(19) United States
(12) Patent Application Publication
(10) Pub. No.: US 2026/0032378 A1
(43) Pub. Date: Jan. 29, 2026

(54) Ultrasound Attenuation for Transducers

(71) Applicant: Apple Inc., Cupertino, CA (US)

(72) Inventors: Onur I. Ilkorur, Santa Clara, CA (US); Tom-Davy W. Saux, Los Gatos, CA (US); Gokhan Hatipoglu, Milpitas, CA (US); Peter C. Hrudey, San Jose, CA (US); Christopher Wilk, Los Gatos, CA (US)

(21) Appl. No.: 19/253,152

(22) Filed: Jun. 27, 2025

Related U.S. Application Data
(60) Provisional application No. 63/674,684, filed on Jul. 23, 2024.
(60) Provisional application No. 63/811,325, filed on May 23, 2025.

(51) Int. Cl. H04R 1/28; H04R 1/02

(52) U.S. Cl. CPC H04R 1/2888; H04R 1/025; H04R 1/028

(57) ABSTRACT

A transducer attenuator assembly comprising: an enclosure defining an acoustic chamber coupled to a sound output port of a transducer that is operable to generate audible frequencies from ultrasonic frequencies; and a plurality of openings formed through the enclosure to acoustically couple the acoustic chamber to a surrounding ambient environment, and the plurality of openings are arranged to attenuate an ultrasonic sound wave and leak an audible sound wave output by the transducer to the acoustic chamber.

### CROSS-REFERENCE TO RELATED APPLICATION

This application is a non-provisional application of co-pending U.S. Provisional Patent Application No. 63/674,684, filed Jul. 23, 2024, and U.S. Provisional Patent Application No. 63/811,325, filed May 23, 2025, and incorporated herein by reference.

### FIELD

An aspect of the disclosure is directed to attenuators for attenuating ultrasonic frequencies while leaking low frequencies associated with transducers. Other aspects are also described and claimed.

### BACKGROUND

Portable communications or listening devices (e.g., smart phones, earphones, etc.) have within them one or more transducers that convert an input electrical audio signal into a sound pressure wave output that can be heard by the user, or a sound pressure wave input into an electrical audio signal. The transducer (e.g., a speaker) can be used to, for example, output sound pressure waves corresponding to the voice of a far end user, such as during a telephone call, or to output sound pressure waves corresponding to sounds associated with a game or music the user wishes to play. Due to the relatively low profile of the portable devices, the transducers also have a relatively low profile, which in turn, can make it difficult to maintain optimal sound quality. In addition, it may be desirable to attenuate certain ultrasound amplitudes or frequency ranges output by the transducers or otherwise near the ear of the user for health and safety reasons, while still outputting lower frequencies to the user's ear.

### SUMMARY

Aspects of the disclosure are directed to attenuators for attenuating ultrasonic frequencies associated with transducer or speaker architectures, for example microelectromechanical systems (MEMS) transducers, that use ultrasonic frequencies to generate audio frequencies. Representatively, when generating audio tones using MEMS transducers operating at high frequencies there may inevitably be some ultrasonic energy at the eardrum, in addition to the lower frequencies or sound desired at the eardrum. For example, a MEMS transducer or speaker may use ultrasonic modulation and demodulation techniques to generate audible sound. Ultrasonic modulation and demodulation speaker techniques generate an audible sound from modulated ultrasound using an amplitude-modulated ultrasonic wave that follows the amplitude of the intended audio signal. The modulated ultrasound is demodulated to produce the intended audible sound output. It is difficult, however, to separate the ultrasonic energy from the lower frequency audible sound desired near the ear. Aspects of the instant disclosure are therefore directed to attenuator architectures for use with transducers that use ultrasonic frequencies to generate audio frequencies to attenuate undesired ultrasonic frequencies or energy near the ear. In some aspects, the attenuators the undesirable ultrasonic frequencies to within a range of less than 94 decibels (dB), or more preferably within a range of from 7-40 dB.

In some aspects, the disclosure is directed to a transducer attenuator assembly comprising: an enclosure defining an acoustic chamber coupled to a sound output port of a transducer that is operable to generate audible frequencies from ultrasonic frequencies; and a plurality of openings formed through the enclosure to acoustically couple the acoustic chamber to a surrounding ambient environment, and the plurality of openings are arranged to attenuate an ultrasonic sound wave and leak an audible sound wave output by the transducer to the acoustic chamber. In some aspects, at least one opening of the plurality of openings is aligned with a pressure minimum point of the ultrasonic sound wave. In still further aspects, the enclosure comprises a rectangular tube having an end coupled to the sound output port of the transducer, a side arranged perpendicular to the end, and the plurality of openings are formed through the side. In other aspects, the ultrasonic sound wave forms a longitudinal standing wave within the acoustic chamber, and each of the plurality of openings are aligned with a pressure minimum point of the longitudinal standing wave. In some aspects, the enclosure comprises a disc having a first side comprising a center opening acoustically coupled to the sound output port of the transducer, and a second side arranged parallel to the first side through which the plurality of openings are formed. In still further aspects, the ultrasonic sound wave forms a meridional standing wave within the acoustic chamber, and each of the plurality of openings are aligned with a pressure minimum point of the meridional standing wave. In some aspects, the plurality of openings are arranged in a pattern of concentric rings along the second side of the disc. In still further aspects, the enclosure comprises a cone having a first side comprising an apex with a center opening coupled to the sound output port of the transducer, and a second side arranged parallel to the first side through which the plurality of openings are formed. In other aspects, at least one opening of the plurality of openings defines a main channel extending from the acoustic chamber to the surrounding ambient environment, and a secondary channel extending from a side wall of the main channel that is tuned to attenuate the ultrasonic sound wave. In some aspects the assembly further includes a housing coupled to a side of the enclosure through which the plurality of openings are formed and having a port to the surrounding ambient environment, and a chip scale attenuator acoustically coupled to the port to attenuate a remnant ultrasonic frequency wave within the housing. In some aspects, at least one opening of the plurality of openings comprises a cluster of openings. A protective membrane and a movable tuning plate may further be arranged over the cluster of openings, and the movable tuning plate is operable to open openings within the cluster of openings aligned with a pressure minimum point of the ultrasonic sound wave and close openings within the cluster of openings misaligned with the pressure minimum point.

In other aspects, a portable electronic device includes a device enclosure having an enclosure wall defining an interior chamber separated from a surrounding ambient environment; a transducer attenuator coupled to the device enclosure and defining an acoustic chamber within the interior chamber that is coupled to a sound output port of a transducer operable to generate audible sound waves from ultrasonic sound waves; and a plurality of openings formed through the transducer attenuator to acoustically couple the acoustic chamber to the surrounding ambient environment, and at least one opening of the plurality of openings is aligned with a pressure minimum point of an ultrasonic sound wave output by the transducer to the acoustic chamber. In some aspects, the plurality of openings are aligned with a plurality of pressure minimum points of the ultrasonic sound wave to attenuate the ultrasonic sound wave and leak an audible sound wave output by the transducer to the acoustic chamber. In other aspects, the transducer attenuator comprises a sealed end transmission line having a length that is an integer multiple of the ultrasonic sound wave output by the transducer, and the plurality of openings are arranged along the length of the transmission line to align the at least one opening with the pressure minimum point of the ultrasonic sound wave. In some aspects, the transducer attenuator comprises a hollow disc having a first side comprising a center opening coupled to the sound output port of the transducer, and a second side arranged parallel to the first side through which the plurality of openings are formed. In other aspects, the ultrasonic sound wave forms a meridional standing wave within the acoustic chamber, and each of the plurality of openings are aligned with a pressure minimum point of the meridional standing wave. In some aspects, the transducer attenuator comprises a cone having a first side comprising an apex with a center opening coupled to the sound output port of the transducer, and a second side arranged parallel to the first side through which the plurality of openings are formed. In other aspects, at least one opening of the plurality of openings defines a main channel extending from the acoustic chamber to the surrounding ambient environment, and a secondary channel extending from a side wall of the main channel that is tuned to attenuate the ultrasonic sound wave. In some aspects, a housing is coupled to a side of the transducer attenuator through which the plurality of openings are formed and having a port to the surrounding ambient environment, and a chip scale attenuator acoustically coupled to the port to attenuate a remnant ultrasonic sound wave within the housing. In other aspects, the device enclosure comprises a wearable device enclosure.

The above summary does not include an exhaustive list of all aspects of the present disclosure. It is contemplated that the disclosure includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWINGS

The aspects are illustrated by way of example and not by way of limitation in the figures of the accompanying drawings in which like references indicate similar elements. It should be noted that references to “an” or “one” aspect in this disclosure are not necessarily to the same aspect, and they mean at least one.

FIG. 1 illustrates a cross-sectional side view of one aspect of an attenuator assembly.

FIG. 2 illustrates a perspective view of the attenuator assembly of FIG. 1.

FIG. 3 illustrates a cross-sectional side view of another aspect of an attenuator assembly.

FIG. 4 illustrates a top plan view of an aspect of the attenuator assembly of FIG. 3.

FIG. 5 illustrates a cross-sectional side view of another aspect of an attenuator assembly.

FIG. 6A illustrates a cross-sectional side view of another aspect of an attenuator assembly.

FIG. 6B illustrates a perspective magnified cross-sectional view of an aspect of the attenuator assembly of FIG. 6A.

FIG. 7 illustrates a perspective magnified cross-sectional view of another aspect of the attenuator assembly of FIG. 6A.

FIG. 8 illustrates a cross-sectional side view of another aspect of an attenuator assembly.

FIG. 9 illustrates a cross-sectional side view of another aspect of an attenuator assembly.

FIG. 10 illustrates a top plan view of the attenuator assembly of FIG. 9.

FIG. 11 illustrates a top plan view of another aspect of the attenuator assembly of FIG. 9.

FIG. 12 illustrates a top plan view of another aspect of an attenuator assembly.

FIG. 13 illustrates a block diagram of one aspect of an electronic device within which the attenuator assembly of FIG. 1-FIG. 12 may be implemented.

### DETAILED DESCRIPTION

In this section we shall explain several preferred aspects of this disclosure with reference to the appended drawings. Whenever the shapes, relative positions and other aspects of the parts described are not clearly defined, the scope of the disclosure is not limited only to the parts shown, which are meant merely for the purpose of illustration. Also, while numerous details are set forth, it is understood that some aspects of the disclosure may be practiced without these details. In other instances, well-known structures and techniques have not been shown in detail so as not to obscure the understanding of this description.

The terminology used herein is for the purpose of describing particular aspects only and is not intended to be limiting of the disclosure. Spatially relative terms, such as “beneath”, “below”, “lower”, “above”, “upper”, and the like may be used herein for ease of description to describe one element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (e.g., rotated 90 degrees or at other orientations) and the spatially relative descriptors used herein interpreted accordingly.

As used herein, the singular forms “a”, “an”, and “the” are intended to include the plural forms as well, unless the context indicates otherwise. It will be further understood that the terms “comprises” and/or “comprising” specify the presence of stated features, steps, operations, elements, and/or components, but do not preclude the presence or addition of one or more other features, steps, operations, elements, components, and/or groups thereof.

The terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

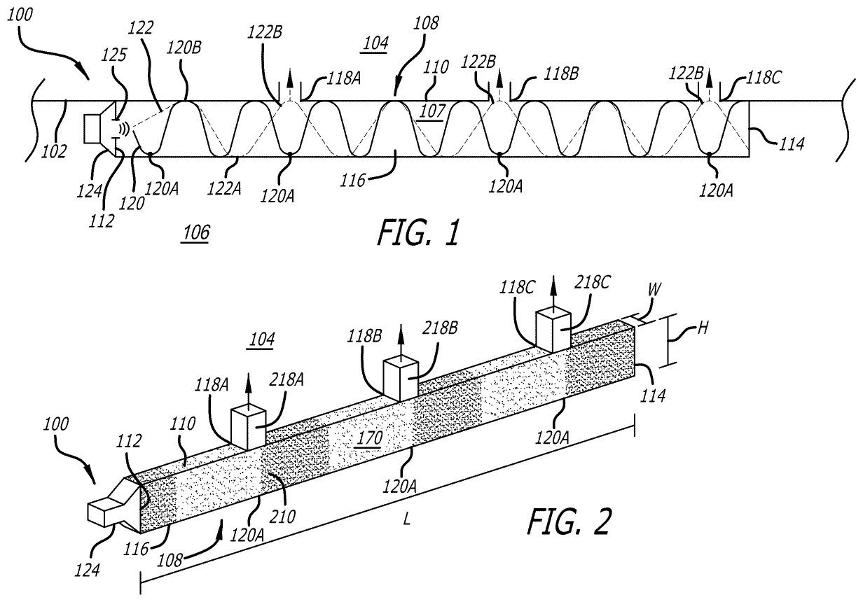

FIG. 1 illustrates a cross-sectional side view of an aspect of an attenuator assembly. Attenuator assembly 100 may include an enclosure or housing 102 having one or more walls or portions that are sealed together to form an interior cavity or chamber 106 that is separated from a surrounding ambient environment 104. Enclosure or housing 102 may be a relatively rigid structure that forms an electronic device enclosure. Representatively, in some aspects, enclosure or housing 102 may form an earpiece or a wearable device enclosure, for example the temple or arm of glasses that rests over an car. In some aspects, the portions or walls may be considered fixed structures that can be snap-fit, welded, adhered or attached in a sealed manner together to form the desired type of housing 102. The interior chamber 106 defined by housing 102 may contain a transducer 124 configured to generate audible sound that may be output to the surrounding ambient environment 104, and more specifically, an ear of a nearby user. In some aspects, transducer 124 may be a microelectromechanical systems (MEMS) transducer or speaker that uses ultrasonic modulation and demodulation techniques to generate the audible sound. Ultrasonic modulation and demodulation speaker techniques generate an audible sound from modulated ultrasound using an amplitude-modulated ultrasonic wave that follows the amplitude of the intended audio signal. The modulated ultrasound is demodulated to produce the intended audible sound output. In addition to the audible sound, however, there may be ultrasonic frequencies that are also output to the ambient environment.

To reduce the output of the ultrasonic frequencies to the ambient environment, and more particularly near the ear, transducer 124 may be coupled to attenuator 108 which is configured to attenuate undesirable ultrasonic frequencies output by transducer 124 before reaching the ambient environment 104. Representatively, attenuator 108 may be connected at one end to a sound output port 125 of transducer 124 and be configured to output or otherwise leak audible or desired sound to the ambient environment 104 while attenuating or otherwise preventing the output of undesirable ultrasonic waves or frequencies. Representatively, attenuator 108 may be formed by one or more walls 110, 112, 114, 116 that are connected to housing 102 and define an acoustic chamber 107. For example, attenuator 108 may include a side wall 110 and a side wall 116 that run parallel to one another and are connected by an end wall 114 that closes or otherwise seals the end of acoustic chamber 107. The other end wall 112 of attenuator 108 may be open, or otherwise form an opening, and be coupled to a transducer 124. Transducer 124 may output acoustic waves 120, 122 into acoustic chamber 107 of attenuator 108. Attenuator 108 may further include a number of openings 118A, 118B, 118C between acoustic chamber 107 and ambient environment 104 to output audible sound or acoustic waves to the ambient environment 104 (e.g., to an car of a nearby user). Openings 118A-C may be formed at positions and/or locations along side wall 110 of attenuator 108 selected to output or otherwise leak audible or desired sound waves through openings 118A-C to the surrounding ambient environment 104, while attenuating or otherwise preventing undesirable ultrasonic frequencies from leaking through openings 118A-C.

Representatively, as previously discussed, transducer 124 may output audible sounds using modulation/demodulation techniques by generating a carrier frequency and/or a modulator frequency, which may be output into acoustic chamber 107 of attenuator 108 as represented by acoustic wave 120. The carrier and/or modulator frequencies represented by acoustic wave 120 may be within an ultrasonic frequency range that is not desirable to be output through openings 118A-C to the ambient environment (e.g., near an car of a user). To attenuate these undesirable ultrasonic frequencies, attenuator 108 may have a length that is an integer (N) multiple of the wavelength of a frequency of the carrier and/or modulator frequency represented by acoustic wave 120. Acoustic wave 120 (e.g., representing the carrier frequency) forms a longitudinal wave within the acoustic chamber 107 having pressure minimum points represented by dips or nulls 120A and pressure maximum points represented by peaks 120B along its length. This pattern may be referred to as a standing wave, as the progressing waves and the reflected waves coincide at the same location at the same time intervals over the length. In the case of having another acoustic wave 122 within acoustic chamber 107 which is very low in frequency compared to the ultrasonic frequencies (e.g., a demodulated audible tone around 1 kHz desired to be output to the user's ear), the pressure minimum points or nulls 122A and pressure maximum points or peaks 122B of wave 122 will not share all the same locations of the standing wave 120. Rather, acoustic wave 122 may have pressure maximum points or peaks 122B at locations along attenuator 108 which coincide with some of the pressure minimum points or nulls 120A of acoustic wave 120 as shown. At the pressure minimum points, there will be no or only minimal energy flow (e.g., close to zero pressure), while at the pressure maximum points there will be maximum energy flow. Accordingly, forming openings 118A-C at locations along attenuator side wall 110 that coincide with pressure minimum points 120A of the high frequency wave 120 (e.g., ultrasonic frequency wave) and the pressure maximum points of the low frequency wave 122 (e.g., audible frequency wave) as shown, will allow the desired audible tone represented by low frequency wave 122 to leak out of openings 118A-C without leaking, or with only minimal leaking of, the ultrasonic frequencies represented by wave 120 through openings 118A-C. In this aspect, attenuator 108 outputs the desired audio tones (e.g., within an audible frequency range) from transducer 124 to the ambient environment 104 while attenuating the undesirable ultrasonic frequencies (e.g., within an ultrasonic frequency range).

Various aspects of attenuator 108 may be tuned to achieve the desired attenuation of ultrasonic frequencies as will now be discussed in more detail in reference to FIG. 2. FIG. 2 illustrates a side perspective view of attenuator 108 of FIG. 1. From this view, it can be seen that attenuator 108 may have an elongated rectangular shape defined by a length dimension (L), a height dimension (H), and a width dimension (W). In addition, each of openings 118A-C formed through side wall 110 may be acoustically coupled to channels 218A, 218B, 218C extending from side wall 110 to the ambient environment 104. The size and/or dimensions of any one or more of these aspects of attenuator 108 may be selected to attenuate the desired ultrasonic frequencies. Representatively, the selectivity of attenuator 108 to leaking certain frequencies while attenuating others may be defined by the dimensions or number of openings 118A-C and/or channels 118A-C. For example, the narrower the openings 118A-C and/or channels 218A-C are, the greater the selectivity and ability to prevent ultrasonic frequencies from leaking out of attenuator 108. The openings 118A-C and/or channels 218A-C, however, should not be so narrow that output and overall efficiency for leaking the desired frequencies drops. Thus, openings 118A-C and/or channels 218A-C may be tuned to have a size, shape and/or dimension that prevents ultrasonic frequency leakage while still maximizing the output of the desired audible tones. For example, in some aspects, openings 118A-C and channels 218A-C may have a relatively narrow polygonal shape as shown. In addition, the greater the number of openings 118A-C and associated channels 218A-C, the greater the desired audio band output. Since, however, openings 118A-C must coincide with the minimum pressure points or nulls of the carrier frequency 120 and there are a limited number of nulls of the carrier frequency within acoustic chamber 107, the side walls of attenuator 108 may be increased for higher output requirements. For example, the length (L), height (H) or width (W) of side walls 110, 112, 114, 116 and/or 210 may be increased for higher output requirements. In addition, as previously discussed the length (L) may be an integer (N) multiple of the wavelength (e.g., N×Wavelength) of a frequency represented by acoustic wave 120, for example the carrier frequency. In this aspect, if a higher carrier frequency is selected, the attenuator dimensions (e.g., length (L)) may be reduced to achieve the desired attenuation. Alternatively, if a higher number of openings 118A-C is desired (e.g., to improve audio band output) than the attenuator dimensions allow, a higher carrier frequency having a greater number of null points may be selected which, in turn, allows for a greater number of openings 118A-C along attenuator 108. In the illustrated configuration, three openings 118A-C are illustrated, however, it is contemplated that more or fewer openings may be formed through side wall 110 of attenuator 108. In addition, although openings 118A-C and the associated channels 218A-C are shown along side wall 110, it is contemplated that they may be formed along a different side wall, for example side wall 116, depending on the desired direction of sound output. In addition, although transducer 124 is shown attached to end wall 112 and outputting acoustic waves in a direction parallel to side walls 110, 116, and perpendicular to a direction of sound output through openings 118A-C, it is contemplated that transducer 124 may be attached to other portions or walls of attenuator 108 (e.g., end wall 114). In addition, it should be understood that in some aspects, openings 118A-C may not all be open all the way to the closed end 114 of attenuator 108. Rather, in order to support the standing wave build-up inside attenuator 108, one or two of openings 118A-C, for example openings 118B and 118C may be closed. This helps the standing wave reach a higher pressure gradient between the peeks and the nulls, allowing the air-nonlinearity demodulation to become more efficient in the demodulation.

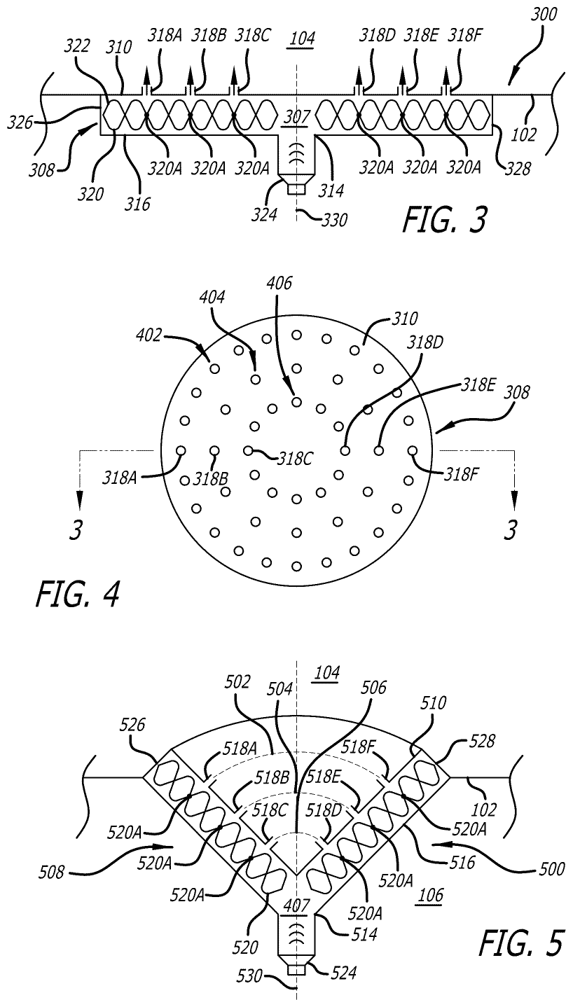

Referring now to FIG. 3, FIG. 3 illustrates a cross-sectional side view of another aspect of an attenuator assembly 300. Attenuator assembly 300 includes similar aspects and operates in a similar manner to attenuator assembly 100 to attenuate ultrasonic frequencies while leaking audible tones. Attenuator assembly 300, however, has a different geometry than that of attenuator assembly 100. Representatively, attenuator assembly 300 may include an attenuator 308 having a hollow disc or cylindrical shaped geometry that is coupled at its center to the transducer 324 to radiate acoustic waves from the center of attenuator 308. For example, similar to the attenuator assembly of FIGS. 1-2, attenuator assembly 300 may include an enclosure or housing 102 having one or more walls or portions that are sealed together to form an interior cavity or chamber 106 that contains transducer 324 and is separated from a surrounding ambient environment 104. Transducer 324 may be a microelectromechanical systems (MEMS) transducer or speaker that uses ultrasonic modulation and demodulation techniques to generate the audible sound. In addition to the audible sound, however, transducer may also output ultrasonic frequencies. To attenuate the undesirable ultrasonic frequencies, transducer 324 may be coupled to attenuator 308, which is configured to attenuate undesirable ultrasonic frequencies output by transducer 324 before reaching the ambient environment 104 (e.g., an car of a nearby user). Representatively, attenuator 308 may be connected at its center to transducer 324 and be configured to output or otherwise leak audible or desired sound to the ambient environment 104 while attenuating or otherwise preventing the output of undesirable ultrasonic frequencies. For example, attenuator 308 may be formed by one or more walls 310, 316 that are connected to housing 102 and define a hollow acoustic chamber 307. Wall 310 may have a circular shape, and wall 316 may have a similar shape and run parallel to wall 310. Both of walls 310, 316 may be planar or flat walls that are sealed to one another around their edges by side walls 326, 328 to form a generally cylindrical acoustic chamber 307. The wall 316 of attenuator 308 may have an opening 314 at its center to which transducer 324 is coupled. Transducer 324 may output acoustic waves 320, 322 into acoustic chamber 307 of attenuator 308. In some aspects, acoustic waves 320, 322 may form a meridional standing wave within the acoustic chamber 307. Attenuator 308 may further include a number of openings 318A, 318B, 318C, 318D, 318E, 318F between acoustic chamber 307 and ambient environment 104 to output audible sound or acoustic waves to the ambient environment 104 (e.g., to an car of a nearby user). Openings 318A-F may be formed at positions and/or locations along wall 310 of attenuator 308 selected to output or otherwise leak audible or desired sound waves through openings 318A-F to the surrounding ambient environment 104, while attenuating or otherwise preventing undesirable ultrasonic frequencies from leaking through openings 318A-F.

Representatively, as previously discussed, transducer 324 may output audible sounds using modulation/demodulation techniques by generating a carrier frequency and/or a modulator frequency, which may be output into acoustic chamber 307 of attenuator 308 as a radial standing wave as represented by acoustic waves 320, 322. The carrier and/or modulator frequencies represented by acoustic waves 320, 322 may be within an ultrasonic frequency range that is not desirable to be output through openings 318A-F to the ambient environment (e.g., near an car of a user). To attenuate these undesirable ultrasonic frequencies, openings 318A-F of attenuator 308 may be formed at locations along attenuator wall 310 that coincide with pressure minimum points 320A of the acoustic waves 320, 322. In this aspect, these ultrasonic frequencies do not leak through openings 318A-F. On the other hand, the much lower frequency audible tones will have pressure maximum points that coincide with openings 318A-F such that the lower frequency audible tones can leak out openings 318A-F to the surrounding ambient environment 104. In this aspect, attenuator 308 outputs the desired audio tones (e.g., lower frequencies within an audible frequency range) from transducer 324 to the ambient environment 104 while attenuating the undesirable ultrasonic frequencies (e.g., within an ultrasonic frequency range).

In some aspects, although only six openings 318A-F can be seen in the cross-sectional view of FIG. 3, there may be more than six openings 318A-F which together form a pattern of openings along wall 310 as can be seen by the top view illustrated in FIG. 4. Representatively, FIG. 3 may be understood as illustrating a cross-sectional side view along line 3-3 of FIG. 4. As can be seen from the top view of attenuator 308 illustrated by FIG. 4, openings 318A-F form a pattern of concentric rings 402, 404, 406 across wall 310. For example, the openings may be arranged to form an inner ring 406, a middle ring 404 and an outer ring 402 that radiate outwardly from the axis of symmetry 330 of attenuator 308. In this aspect, a maximum number of openings may be aligned with each of the null points as well as the maximum pressure points of the audible frequencies within acoustic chamber 307 to maximize the output of the desirable audio tones, while attenuating the undesirable ultrasonic frequencies.

FIG. 5 illustrates a cross-sectional side view of another aspect of an attenuator assembly. Attenuator assembly 500 includes similar aspects and operates in a similar manner to attenuator assembly 100 and 300 to attenuate ultrasonic frequencies while leaking audible tones. Attenuator assembly 500, however, has a different geometry than that of the previously discussed attenuators. Representatively, attenuator assembly 500 may include an attenuator 508 having a hollow conical, funnel or V shaped geometry that is coupled at its center or apex to transducer 524 to radiate acoustic waves from the center of attenuator 508. For example, similar to the attenuator assembly of FIGS. 1-4, attenuator assembly 500 may include an enclosure or housing 102 having one or more walls or portions that are sealed together to form an interior cavity or chamber 106 containing transducer 524 that is separated from a surrounding ambient environment 104. In some aspects, transducer 524 may be a microelectromechanical systems (MEMS) transducer or speaker that uses ultrasonic modulation and demodulation techniques to generate the audible sound. In addition to the audible sound, however, transducer may also output ultrasonic frequencies as previously discussed. To attenuate the undesirable ultrasonic frequencies, transducer 524 may be coupled to attenuator 508, which is configured to attenuate undesirable ultrasonic frequencies output by transducer 524 before reaching the ambient environment 104. Representatively, attenuator 508 may be connected through an opening 514 at its apex to the acoustic output port of transducer 524 and be configured to output or otherwise leak audible or desired sound to the ambient environment 104 while attenuating or otherwise preventing the output of undesirable ultrasonic frequencies. For example, attenuator 508 may be formed by one or more walls 510, 516 that are connected to housing 102 and define a hollow acoustic chamber 507. Wall 510 may in some aspects be considered a top or sound output wall and have a conical, funnel, V shape, or be otherwise non-planar, and wall 516 may be considered a bottom wall that has a similar complimentary shape to wall 510 such that it runs parallel to wall 510. Both of walls 510, 516 may be scaled to one another around their edges by side walls 526, 528 to form a generally cylindrical acoustic chamber 507. The wall 516 (e.g., a bottom wall) of attenuator 508 may have an opening 514 at its center or apex to which transducer 524 is coupled. Transducer 524 may output acoustic waves 520 into acoustic chamber 507 of attenuator 508. Attenuator 508 may further include a number of openings 518A, 518B, 518C, 518D, 518E, 518F between acoustic chamber 507 and ambient environment 104 to output audible sound or acoustic waves to the ambient environment 104 (e.g., to an car of a nearby user). Openings 518A-F may be formed at positions and/or locations along wall 510 (e.g., a top or sound output wall) of attenuator 508 selected to output or otherwise leak audible or desired sound waves through openings 518A-F to the surrounding ambient environment 104, while attenuating or otherwise preventing undesirable ultrasonic frequencies from leaking through openings 518A-F. Representatively, carrier and/or modulator frequencies represented by acoustic waves 520 may be within an ultrasonic frequency range that is not desirable to be output through openings 518A-F to the ambient environment (e.g., near an car of a user). To attenuate these undesirable ultrasonic frequencies, openings 518A-F of attenuator 508 may be formed at locations along attenuator wall 510 that coincide with pressure minimum points 520A of the acoustic waves 520. In this aspect, these ultrasonic frequencies do not leak through openings 518A-F. On the other hand, the much lower frequency audible tones will have pressure maximum points that coincide with openings 518A-F such that the lower frequency audible tones can leak out openings 518A-F to the surrounding ambient environment 104. In addition, although only six openings 518A-F can be seen in the cross-sectional view of FIG. 5, there may be more than six openings 518A-F which together form a pattern of openings along wall 510 similar to the top view illustrated in FIG. 4. Representatively, openings 518A-F form a pattern of concentric rings 502, 504, 506 across wall 510. For example, openings 518A-F may be arranged to form an inner ring 502, a middle ring 504 and an outer ring 506 that radiate outwardly from the axis of symmetry 530 of attenuator 508 for maximum ultrasonic frequency attenuation and desired audible sound output.

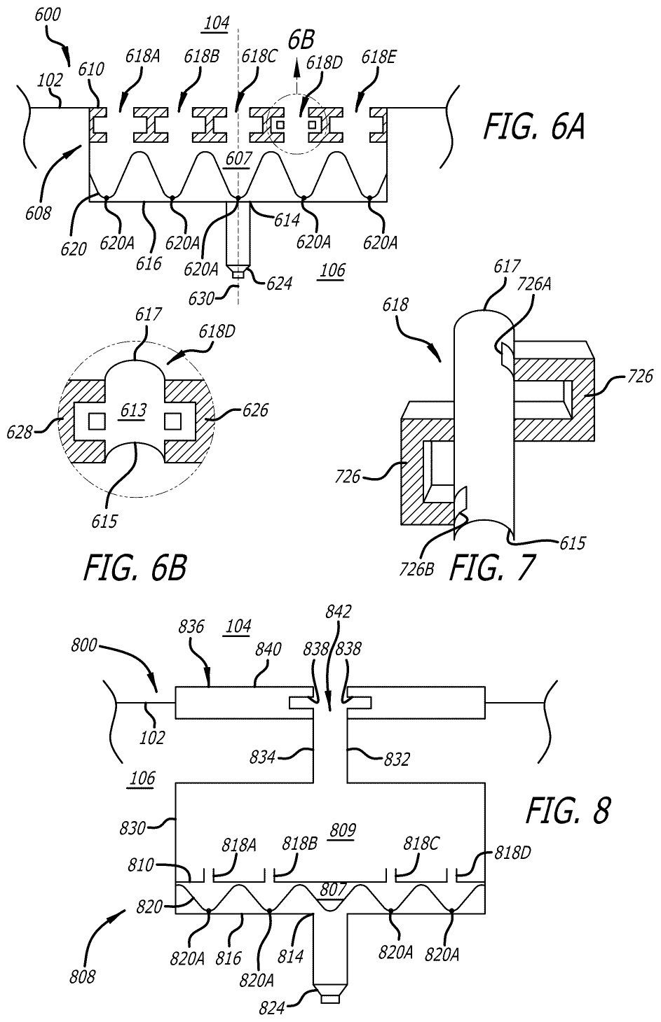

FIG. 6A illustrates a cross-sectional side view of another aspect of an attenuator assembly. Attenuator assembly 600 includes similar aspects and operates in a similar manner to attenuator assemblies 100, 300, 500 to attenuate ultrasonic frequencies while leaking audible tones. Attenuator assembly 600, however, has a different opening geometry than that of the previously discussed attenuators. Representatively, attenuator assembly 600 may include an attenuator 608 having any one of the previously discussed geometries, for example a hollow disc shaped geometry that is coupled at its center to transducer 624 to radiate acoustic waves from the center of attenuator 608. For example, similar to the attenuator assembly of FIGS. 1-5, attenuator assembly 600 may include an enclosure or housing 102 having one or more walls or portions that are sealed together to form an interior cavity or chamber 106 containing transducer 624 and that is separated from a surrounding ambient environment 104. In some aspects, transducer 624 may be a microelectromechanical systems (MEMS) transducer or speaker that uses ultrasonic modulation and demodulation techniques to generate the audible sound, for example to be output to an car of a user. In addition to the audible sound, however, transducer may also output ultrasonic frequencies as previously discussed. To attenuate the undesirable ultrasonic frequencies, transducer 624 may be coupled to attenuator 608, which is configured to attenuate undesirable ultrasonic frequencies output by transducer 624 before reaching the ambient environment 104. Representatively, attenuator 608 may be connected through an opening 614 at its center to a sound output port of a transducer 624 and be configured to output or otherwise leak audible or desired sound to the ambient environment 104 while attenuating or otherwise preventing the output of undesirable ultrasonic frequencies. For example, attenuator 608 may be formed by one or more walls 610, 616 that are connected to housing 102 and define a hollow acoustic chamber 607. Both of walls 610, 616 may be sealed to one another around their edges by side walls 626, 628 to form a generally cylindrical acoustic chamber 607. The wall 616 (e.g., a bottom wall) of attenuator 608 may have an opening 614 at its center to which transducer 624 is coupled. Transducer 624 may output acoustic wave 620 into acoustic chamber 607 of attenuator 608. Attenuator 608 may further include a number of openings 618A, 618B, 618C, 618D, 618E between acoustic chamber 607 and ambient environment 104 to output audible sound or acoustic waves to the ambient environment 104 (e.g., to an car of a nearby user). Openings 618A-E may be formed at positions and/or locations along wall 610 (e.g., a sound output wall) of attenuator 608 selected to output or otherwise leak audible or desired sound waves through openings 618A-E to the surrounding ambient environment 104, while attenuating or otherwise preventing undesirable ultrasonic frequencies from leaking through openings 618A-E. Representatively, carrier and/or modulator frequencies represented by acoustic wave 620 may be within an ultrasonic frequency range that is not desirable to be output through openings 618A-E to the ambient environment (e.g., near an car of a user). To attenuate these undesirable ultrasonic frequencies, openings 618A-E of attenuator 608 may be formed at locations along attenuator wall 610 that coincide with pressure minimum points 620A of the acoustic wave 620. In this aspect, these ultrasonic frequencies do not leak through openings 618A-E. On the other hand, the much lower frequency audible tones will have pressure maximum points that coincide with openings 618A-E such that the lower frequency audible tones can leak out openings 618A-E to the surrounding ambient environment 104. Although only five openings 518A-E can be seen in the cross-sectional view of FIG. 6, there may be more than five openings 618A-E which together form a pattern, such as rings of openings, along wall 610 similar to the top view illustrated in FIG. 4.

In addition, in some aspects, one or more of openings 618A-E may also have a geometry configured to interact with the ultrasonic waves and cause destructive interference to further attenuate any remnant ultrasonic frequencies passing through openings 618A-E. Representatively, as can be seen from the magnified perspective view of opening 618D illustrated in FIG. 6B, opening 618D includes a channel 613 that creates a parallel path of ultrasonic acoustic wave that will interact and cause destructive interference to attenuate any remnant ultrasonic tones. Representatively, opening 618D may include a main channel 613 having a first end 615 open to acoustic chamber 607 and a second end 617 open to the surrounding ambient environment 104. This main channel 613 may run generally parallel to the direction of sound output by the transducer 624, or said another way, axis of symmetry 630. One or more optional secondary channels 626, 628 may branch off of, or are otherwise acoustically coupled to, the main channel 613. For example, secondary channels 626, 628 may be C or sideways U-shaped channels or tubes that extend from the side walls of the main channel 613. Representatively, one of the ends of channels 626, 628 may be connected to, and open near, the first end 615 of the main channel 613 and another end of channels 626, 628 may be connected to, and open near, the second end 617 of the main channel 613. In some aspects, channels 626, 628 may be horizontally aligned with one another as shown, or may be vertically offset. In still further aspects, it is contemplated that main channel 613 and/or secondary channels 626, 628 may have different lengths and/or geometries to attenuate different ultrasonic frequencies. Representatively, one or more of the secondary channels may have a spiral configuration as illustrated in FIG. 7. For example, the secondary channel may be formed by a channel 726 having a first end 726A that is open to, and connected near, the end 617 of main channel 613. From first end 726A, channel 726 then spirals around main channel 613 to a second end 726B that is open to, and connected near, the end 615 of main channel 613 as shown in FIG. 7.

In addition, it should be understood that while main channel 613 having secondary channels 626, 628 is shown, secondary channels 626, 628 may be omitted and the main channel 613 alone may have a geometry, including a particular length and/or width, to attenuate the remnant ultrasonic frequencies. In this aspect, the geometries of the main channel 613 and/or secondary channels 626, 628 alone or in combination may create a parallel path of ultrasonic acoustic wave that will interact and cause destructive interference to attenuate the remnant ultrasonic peaks, similar to the concept of a micro scale Hershel-Quicke (HQ) tube. It should further be understood that while opening 618D of FIG. 6A is described in FIG. 6B, the opening geometries described in reference to FIG. 6B may apply to any of openings 618A-E shown in FIG. 6A, or the openings previously discussed in reference to FIGS. 1-5.

FIG. 8 illustrates a cross-sectional side view of another aspect of an attenuator assembly. Attenuator assembly 800 may include similar aspects and operate in a similar manner to attenuator assemblies 100, 300, 500, 600 to attenuate ultrasonic frequencies while leaking audible tones. Attenuator assembly 800, however, may further include an ultrasonic attenuator chip coupled to attenuator output port(s) or opening(s) to introduce a second level of attenuation. Representatively, attenuator assembly 800 may include an attenuator 808 having any one of the previously discussed geometries, for example a hollow disc shaped geometry that is coupled at its center to transducer 824 to radiate acoustic waves from the center of attenuator 808. For example, similar to the attenuator assembly of FIGS. 1-7, attenuator assembly 800 may include an enclosure or housing 102 having one or more walls or portions that are sealed together to form an interior cavity or chamber 106 that contains transducer 924 and that is separated from a surrounding ambient environment 104. Transducer 824 may be a MEMS transducer configured to use ultrasonic modulation/demodulation techniques to generate audible sound that may be output to the surrounding ambient environment 104, and more specifically, an car of a nearby user. To attenuate any undesirable ultrasonic frequencies, transducer 824 may be coupled to attenuator 808, which is configured to attenuate undesirable ultrasonic frequencies output by transducer 824 before reaching the ambient environment 104. Representatively, attenuator 808 may be connected through an opening 814 at its center to a sound output port of transducer 824 and be configured to output or otherwise leak audible or desired sound to the ambient environment 104 while attenuating or otherwise preventing the output of undesirable ultrasonic frequencies. For example, attenuator 808 may be formed by one or more walls 810, 816 that are connected to housing 102 and sealed to one another to define a hollow acoustic chamber 807. Transducer 824 may output acoustic wave 820 into acoustic chamber 807 of attenuator 808. Attenuator 808 may further include a number of openings 818A, 818B, 818C, 818D between acoustic chamber 807 and ambient environment 104 to output audible sound or acoustic waves to the ambient environment 104 (e.g., to an car of a nearby user). Openings 818A-D may be formed at positions and/or locations along wall 810 (e.g., a top wall) of attenuator 808 selected to output or otherwise leak audible or desired sound waves through openings 818A-D to the surrounding ambient environment 104, while attenuating or otherwise preventing undesirable ultrasonic frequencies from leaking through openings 818A-D, as previously discussed. Representatively, similar to the previously discussed configurations, openings 818A-D of attenuator 808 may be formed at locations along attenuator wall 810 that coincide with pressure minimum points 820A of the acoustic wave 820. In this aspect, these ultrasonic frequencies do not leak through openings 818A-D, while the much lower frequency audible tones will have pressure maximum points that coincide with openings 818A-D such that the lower frequency audible tones can leak out openings 818A-D to the surrounding ambient environment 104.

In some cases, however, there may be remnant ultrasonic frequencies that are found to still leak through openings 818A-D along with the desired lower frequency audible tones. To attenuate these remnant frequencies, ultrasonic chip scale attenuator 836 may further be coupled to one or more of the attenuator output port(s) or opening(s) to introduce a second level of attenuation. For example, attenuator 808 may be configured to attenuate ultrasonic carrier frequencies as previously discussed while chip scale attenuator 836 attenuates wideband ultrasonic frequencies or other frequencies within a different ultrasonic frequency range than the carrier frequency. Representatively, the assembly may include an additional enclosure wall 830 attached to attenuator wall 810 which forms an additional acoustic chamber 809 around openings 818A-D and a neck portion 832 that has an exit port or opening 834 to the surrounding ambient environment 104. Chip scale attenuator 836 may be connected to the exit port or opening 834. Representatively, chip scale attenuator 836 may be formed by a chip or wafer 840 having a pathway 842 extending entirely though wafer 840 and aligned with the opening 834 from acoustic chamber 809. Attenuator or resonator cavities 838 may branch or otherwise be formed off of pathway 842 and include an end that opens to pathway 842 and extend to an enclosed volume or cavity formed within wafer 840. Representatively, in some aspects, cavities 838 may be Helmholtz resonators or sub-wavelength tubes (e.g., half, quarter) that are open at one end to pathway 842 and extend to an enclosed volume of air or cavity formed within wafer 840. In this aspect, cavities 838 may be used to attenuate any remnant ultrasonic frequencies (e.g., wideband frequencies 30-1 MHZ) which may leak through openings 818A-D of attenuator 808 to pathway 842. It is contemplated that in some aspects, the addition of chip scale attenuator 836 may result in at least an additional 10-20 decibels (dB) of ultrasonic attenuation. It should further be understood that secondary chip scale attenuator 836 may be coupled to any of the previously discussed attenuator assemblies 100, 300, 400, 600 that could benefit from additional ultrasonic attenuation.

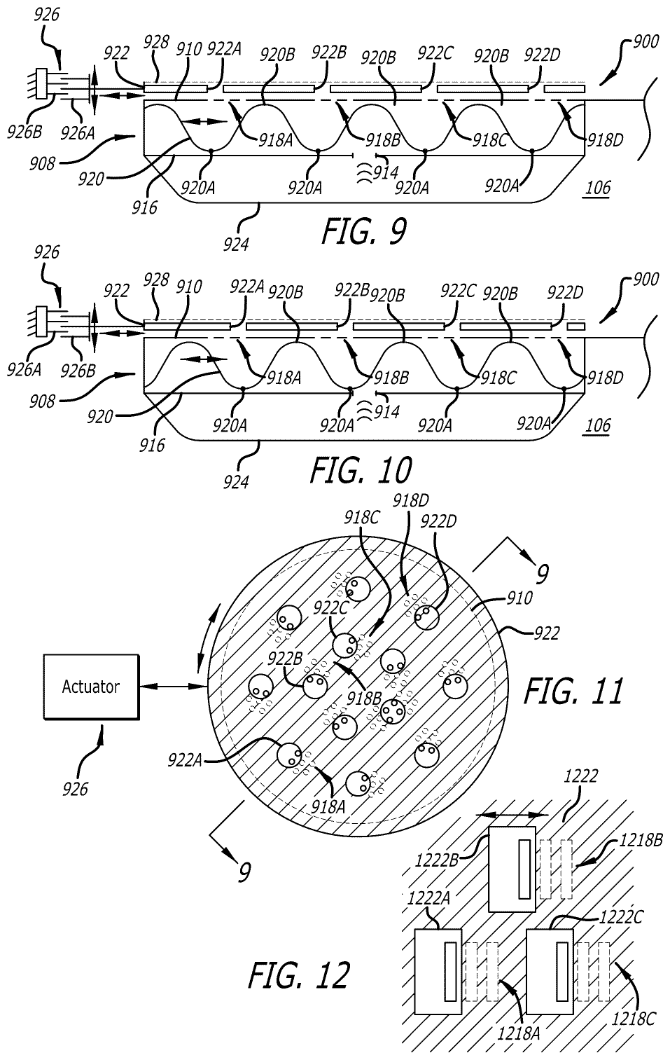

FIGS. 9-10 illustrate a cross-sectional side view of another aspect of an attenuator assembly. Attenuator assembly 900 may include similar aspects and operate in a similar manner to attenuator assemblies 100, 300, 500, 600, 800 to attenuate ultrasonic frequencies while leaking audible tones. Attenuator assembly 900, however, may further include an impedance tuning plate 922 coupled to attenuator 908 to selectively open/close clusters of attenuator openings 918A, 918B, 918C, 918D for improved ultrasonic frequency attenuation. Representatively, attenuator assembly 900 may include an attenuator 908 having any one of the previously discussed geometries, for example a hollow disc shaped geometry that is coupled at its center to transducer 924 to radiate acoustic waves from the center of attenuator 908. For example, similar to the attenuator assembly of FIGS. 1-8, attenuator assembly 900 may include an enclosure or housing 102 having one or more walls or portions that are sealed together to form an interior cavity or chamber 106 containing transducer 924 and that is separated from a surrounding ambient environment 104. Transducer 924 may be a MEMS transducer configured to use ultrasonic modulation/demodulation techniques to generate audible sound that may be output to the surrounding ambient environment 104, and more specifically, an car of a nearby user. To attenuate any undesirable ultrasonic frequencies, transducer 924 may be coupled to attenuator 908, which is configured to attenuate undesirable ultrasonic frequencies output by transducer 924 before reaching the ambient environment 104. Representatively, attenuator 908 may be connected through an opening 914 at its center to transducer 924 and be configured to output or otherwise leak audible or desired sound to the ambient environment 104 while attenuating or otherwise preventing the output of undesirable ultrasonic frequencies. For example, attenuator 908 may be formed by one or more walls 910, 916 that are connected to housing 102 and scaled to one another to define a hollow acoustic chamber 907. Transducer 924 may output acoustic wave 920 into acoustic chamber 907 of attenuator 908. Attenuator 908 may further include clusters of openings 918A-D between acoustic chamber 907 and ambient environment 104 to output audible sound or acoustic waves to the ambient environment 104 (e.g., to an car of a nearby user). In other words, each of openings 918A-D may consist of at least two or more smaller openings that together form a cluster or group of openings through which sound may pass. Clusters of openings 918A-D may be formed at positions and/or locations along wall 910 (e.g., a top wall) of attenuator 908 selected to output or otherwise leak audible or desired sound waves through clusters of openings 918A-D to the surrounding ambient environment 104, while attenuating or otherwise preventing undesirable ultrasonic frequencies from leaking through clusters of openings 918A-D, as previously discussed. Representatively, similar to the previously discussed configurations, clusters of openings 918A-D of attenuator 908 may be formed at locations along attenuator wall 910 that generally coincide with pressure minimum points 920A of the acoustic wave 920. In this aspect, these ultrasonic frequencies do not leak through (or only minimally leak though) clusters openings 918A-D, while the much lower frequency audible tones will have pressure maximum points that coincide with openings 918A-D such that the lower frequency audible tones can leak out clusters of openings 918A-D to the surrounding ambient environment 104.

In addition, assembly 900 may further include an impedance tuning plate 922 to selectively and/or dynamically open/close the clusters of openings 918A-D for improved ultrasonic frequency attenuation. Representatively, in some aspects, a protective filter or membrane 928 having micropores may be positioned over openings 918A-D to protect transducer 924 from environmental factors (e.g., contaminants, water ingress, etc.). Membrane 928 may add impedance and can therefore change or shift the location of the minimum pressure points 920A. This shifting may result in some openings in the clusters of openings 918A-D no longer vertically aligned, or otherwise misaligned, with minimum pressure points 920A. To achieve realignment of openings 918A-D with minimum pressure points 920A, impedance tuning plate 922 may be positioned over the clusters of openings 918A-D to selectively and dynamically open selected openings aligned with minimum pressure points 920A and close openings that are not aligned or misaligned with minimum pressure points 920A.

Representatively, impedance tuning plate 922 may be a plate or other planar structure that has tuning ports 922A, 922B, 922C and 922D positioned over clusters of openings 918A-D, respectively. Plate 922 is further attached to an actuator 926 that is operable to translate and/or rotate plate 922 relative to attenuator 908 to open/close the desired openings within the clusters of openings 918A-D. For example, actuator 926 may be a comb drive or similar finger type actuator including a first static comb 926A having fingers arranged between fingers of a second moving comb 926B that is attached to plate 922. The application of a voltage to actuator 908 may create attractive electrostatic forces between combs 926A, 926B causing them to be drawn together, which, in turn, translates or rotate plate 922 relative to attenuator 908. This translation and/or rotation of plate 922 shifts the position of the plate openings 922A-D relative to the cluster of openings 918A-D so that only openings within the cluster that are aligned with the minimum pressure points 920A are open, and the rest of the openings in the cluster of openings 918A-D are covered by the plate and therefore closed. Representatively, as can be seen from FIG. 9, the plate openings 922A-D are shown aligned with one of the openings in each of the cluster of openings 918A-D which is vertically aligned with the minimum pressure points 920A of the ultrasonic frequency wave 920. The remaining openings in the cluster of openings 918A-D are covered by plate 922 and therefore closed. When the minimum pressure points 920A shift as shown in FIG. 10 (e.g., to the right), actuator 926 moves plate 922 relative to the cluster of openings 918A-D to cover (e.g., close) the openings which are no longer aligned with points 920A and open other openings within the cluster of openings 918A-D which are aligned with points 920A. Representatively, as can be seen from the top view illustrated by FIG. 11, openings 922A-D of plate 922 may be circular openings which are larger than each of the openings in cluster of openings 918A-C so that they align with some of the circular openings in cluster of openings 918A-D, while the remainder of the openings are covered by plate 922 as shown. In addition, openings 922A-D are shown formed through plate 922 in a similar ring like pattern or arrangement as the underlying openings 918A-D as shown in FIG. 11. It is further contemplated, however, that any other arrangement or shape of plate openings 922A-D and/or cluster of openings 918A-D sufficient to selectively and dynamically open/close cluster of openings 918A-D as described herein may be used.

FIG. 12 illustrates an alternative tuning plate and opening shape and arrangement. Representatively, in this configuration, each of the openings in a cluster of openings 1218A-C formed in the attenuator (e.g., attenuator 908) may have a polygonal shape, for example, a rectangular shape. In addition, each of openings 1222A, 1222B, 1222C formed in tuning plate 1222 may also have a polygonal shape, for example a rectangular shape, and be of a size larger than each of the openings in the cluster of openings 1218A-C. In this aspect, shifting of tuning plate 1222 relative to openings 1218A-C in the attenuator may result in openings 1222A-C aligned with some of the opening in the cluster of openings 1218A-C, while other openings in the cluster of openings are covered (e.g., closed) by plate 1222, as shown. In still further aspects, it is contemplated that a single large plate opening in the tuning plate may be used to selectively open/close the desired openings in the clusters of openings.

In addition, it should be understood that the minimum pressure points of the ultrasonic frequency wave form (e.g., points 920A) without the acoustic impedance added by membrane 928 as well with the added impedance are known and can be programmed into the system. The system also knows the location of the openings in the tuning plate and attenuator, thus the system can determine which openings in the attenuator are aligned with the minimum pressure points and need to be opened, and which are misaligned and therefore need to be closed. In this aspect, the system can cause the actuator to shift (e.g., rotate or translate) the tuning plate to dynamically tune the attenuation by opening/closing the desired attenuator openings based on the location of the minimum pressure points. Representatively, in some aspects, the system may determine the minimum pressure points 920A are at a first location and certain ones of the openings 918A-D of the attenuator 908 are aligned with the points 920A, and plate openings 922B-D are also aligned with openings 918A-D and points 920A, and therefore maximum attenuation of the ultrasonic frequencies is achieved. Once, however, the system detects a shift in the minimum pressure points 920A, the system may determine that points 920A are at a different or second location that no longer aligns with attenuator openings 918A-D. The system may then apply a voltage to the actuator causing plate 922 to shift to another position in which plate 922 covers some of the openings 918A-D that are now misaligned with points 920A, while opening any of the openings 918A-D which are now aligned with points 920A by aligning the plate openings 922A-D with those openings.

In still further aspects, it is contemplated that impedance tuning plate 922 and/or 1222 and membrane 928 may be manufactured as a single unit such that membrane 928 is connected to plate 922, 1222. For example, membrane 928 may be positioned over, and attached to, plate 922, 1222. In this aspect, tuning plate 922 and/or 1222 may provide the additional advantage of being a structural support for membrane 928. Representatively, membrane 928 may be flexible or have at least some minimum level of compliance such that it may bend or move in response to certain environmental pressures (e.g., water pressure) which could cause it to unintentionally block underlying attenuator openings. The presence of plate 922 between membrane 928 and the attenuator, however, provides support to membrane 928 and prevents it from bending or otherwise moving in a way that could block the attenuator openings.

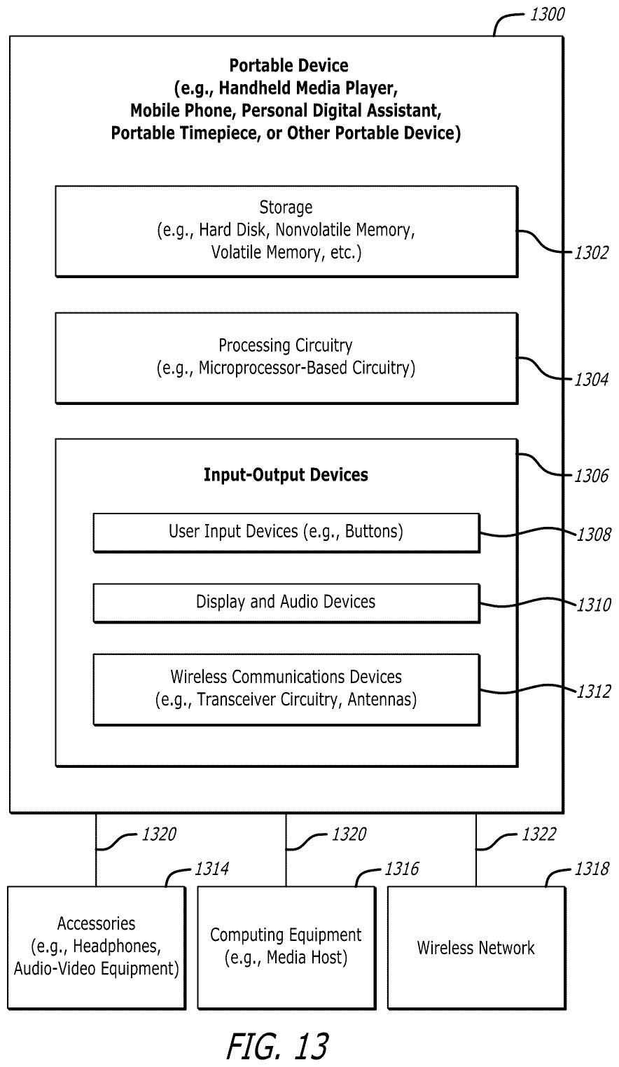

Referring now to FIG. 13, FIG. 13 illustrates a block diagram of one aspect of an electronic device within which the previously discussed speaker may be implemented. As shown in FIG. 13, device 1300 may include storage 1302. Storage 1302 may include one or more different types of storage such as hard disk drive storage, nonvolatile memory (e.g., flash memory or other electrically-programmable-read-only memory), volatile memory (e.g., battery-based static or dynamic random-access-memory), etc.

Processing circuitry 1304 may be used to control the operation of device 1300. Processing circuitry 1304 may be based on a processor such as a microprocessor and other suitable integrated circuits. With one suitable arrangement, processing circuitry 1304 and storage 1302 are used to run software on device 1300, such as internet browsing applications, voice-over-internet-protocol (VOIP) telephone call applications, email applications, media playback applications, operating system functions, etc. Processing circuitry 1304 and storage 1302 may be used in implementing suitable communications protocols. Communications protocols that may be implemented using processing circuitry 1304 and storage 1302 include internet protocols, wireless local area network protocols (e.g., IEEE 802.11 protocols—sometimes referred to as Wi-Fi®), protocols for other short-range wireless communications links such as the Bluetooth® protocol, protocols for handling 3G or 4G communications services (e.g., using wide band code division multiple access techniques), 2G cellular telephone communications protocols, etc.

To minimize power consumption, processing circuitry 1304 may include power management circuitry to implement power management functions. For example, processing circuitry 1304 may be used to adjust the gain settings of amplifiers (e.g., radio-frequency power amplifier circuitry) on device 1300. Processing circuitry 1304 may also be used to adjust the power supply voltages that are provided to portions of the circuitry on device 1300. For example, higher direct-current (DC) power supply voltages may be supplied to active circuits and lower DC power supply voltages may be supplied to circuits that are less active or that are inactive. If desired, processing circuitry 1304 may be used to implement a control scheme in which the power amplifier circuitry is adjusted to accommodate transmission power level requests received from a wireless network.

Input-output devices 1306 may be used to allow data to be supplied to device 1300 and to allow data to be provided from device 1300 to external devices. Display screens, microphone acoustic ports, speaker acoustic ports, and docking ports are examples of input-output devices 1306. For example, input-output devices 1306 can include user input-output devices 1308 such as buttons, touch screens, joysticks, click wheels, scrolling wheels, touch pads, key pads, keyboards, microphones, cameras, etc. A user can control the operation of device 1300 by supplying commands through user input devices 1308. Display and audio devices 1310 may include liquid-crystal display (LCD) screens or other screens, light-emitting diodes (LEDs), and other components that present visual information and status data. Display and audio devices 1310 may also include audio equipment such as speakers and other devices for creating sound. Display and audio devices 1310 may contain audio-video interface equipment such as jacks and other connectors for external headphones and monitors.

Wireless communications devices 1312 may include communications circuitry such as radio-frequency (RF) transceiver circuitry formed from one or more integrated circuits, power amplifier circuitry, passive RF components, antennas, and other circuitry for handling RF wireless signals. Wireless signals can also be sent using light (e.g., using infrared communications). Representatively, in the case of a speaker acoustic port, the speaker may be associated with the port and be in communication with an RF antenna for transmission of signals from the far end user to the speaker.

Returning to FIG. 13, device 1300 can communicate with external devices such as accessories 1314, computing equipment 1316, and wireless network 1318 as shown by paths 1320 and 1322. Paths 1320 may include wired and wireless paths. Path 1322 may be a wireless path. Accessories 1314 may include headphones (e.g., a wireless cellular headset or audio headphones) and audio-video equipment (e.g., wireless speakers, a game controller, or other equipment that receives and plays audio and video content), a peripheral such as a wireless printer or camera, etc.

Computing equipment 1316 may be any suitable computer. With one suitable arrangement, computing equipment 1316 is a computer that has an associated wireless access point (router) or an internal or external wireless card that establishes a wireless connection with device 1300. The computer may be a server (e.g., an internet server), a local area network computer with or without internet access, a user's own personal computer, a peer device (e.g., another portable electronic device), or any other suitable computing equipment.

Wireless network 1318 may include any suitable network equipment, such as cellular telephone base stations, cellular towers, wireless data networks, computers associated with wireless networks, etc. For example, wireless network 1318 may include network management equipment that monitors the wireless signal strength of the wireless handsets (cellular telephones, handheld computing devices, etc.) that are in communication with network 1318.

While certain aspects have been described and shown in the accompanying drawings, it is to be understood that such aspects are merely illustrative of and not restrictive on the broad disclosure, and that the disclosure is not limited to the specific constructions and arrangements shown and described, since various other modifications may occur to those of ordinary skill in the art. The description is thus to be regarded as illustrative instead of limiting. For example, although a speaker is specifically disclosed herein, the attenuators disclosed herein could be used with other types of transducers, for example, microphones. Still further, although a portable electronic device such as a wearable device including smart glasses or other head mounted devices, is described herein, any of the previously discussed attenuator and transducer configurations may be implemented within other devices such as earbuds, headphones, a mobile communications device, a tablet computer, personal computer, laptop computer, notebook computer and the like. In addition, to aid the Patent Office and any readers of any patent issued on this application in interpreting the claims appended hereto, applicants wish to note that they do not intend any of the appended claims or claim elements to invoke 35 U.S.C. 112 (f) unless the words “means for” or “step for” are explicitly used in the particular claim.

What is claimed is:

1. A transducer attenuator assembly comprising:
an enclosure defining an acoustic chamber coupled to a sound output port of a transducer that is operable to generate audible frequencies from ultrasonic frequencies; and
a plurality of openings formed through the enclosure to acoustically couple the acoustic chamber to a surrounding ambient environment, and the plurality of openings are arranged to attenuate an ultrasonic sound wave and leak an audible sound wave output by the transducer to the acoustic chamber.

2. The transducer attenuator assembly of claim 1 wherein at least one opening of the plurality of openings is aligned with a pressure minimum point of the ultrasonic sound wave.

3. The transducer attenuator assembly of claim 1 wherein the enclosure comprises a rectangular tube having an end coupled to the sound output port of the transducer and the plurality of openings are formed through a side of the rectangular tube at locations aligned with a pressure minimum point of a longitudinal standing wave formed by the ultrasonic sound wave.

4. The transducer attenuator assembly of claim 1 wherein the enclosure comprises a disc having a first side comprising a center opening acoustically coupled to the sound output port of the transducer, and a second side arranged parallel to the first side through which the plurality of openings are formed.

5. The transducer attenuator assembly of claim 4 wherein the ultrasonic sound wave forms a meridional standing wave within the acoustic chamber, and each of the plurality of openings are aligned with a pressure minimum point of the meridional standing wave.

6. The transducer attenuator assembly of claim 4 wherein the plurality of openings are arranged in a pattern of concentric rings along the second side of the disc.

7. The transducer attenuator assembly of claim 1 wherein the enclosure comprises a cone having a first side comprising an apex with a center opening coupled to the sound output port of the transducer, and a second side arranged parallel to the first side through which the plurality of openings are formed.

8. The transducer attenuator assembly of claim 1 wherein at least one opening of the plurality of openings defines a main channel extending from the acoustic chamber to the surrounding ambient environment, and a secondary channel extending from a side wall of the main channel that is tuned to attenuate the ultrasonic sound wave.

9. The transducer attenuator assembly of claim 1 further comprising a housing coupled to a side of the enclosure through which the plurality of openings are formed and having a port to the surrounding ambient environment, and a chip scale attenuator acoustically coupled to the port to attenuate a remnant ultrasonic frequency wave within the housing.

10. The transducer attenuator assembly of claim 1 wherein at least one opening of the plurality of openings comprises a cluster of openings.

11. The transducer attenuator assembly of claim 10 further comprises a protective membrane and a movable tuning plate arranged over the cluster of openings, and the movable tuning plate is operable to open openings within the cluster of openings aligned with a pressure minimum point of the ultrasonic sound wave and close openings within the cluster of openings misaligned with the pressure minimum point.

12. A portable electronic device comprising:
a device enclosure having an enclosure wall defining an interior chamber separated from a surrounding ambient environment;
a transducer attenuator coupled to the device enclosure and defining an acoustic chamber within the interior chamber that is coupled to a sound output port of a transducer operable to generate audible sound waves from ultrasonic sound waves; and
a plurality of openings formed through the transducer attenuator to acoustically couple the acoustic chamber to the surrounding ambient environment, and at least one opening of the plurality of openings is aligned with a pressure minimum point of an ultrasonic sound wave output by the transducer to the acoustic chamber.

13. The portable electronic device of claim 12 wherein the plurality of openings are aligned with a plurality of pressure minimum points of the ultrasonic sound wave to attenuate the ultrasonic sound wave and leak an audible sound wave output by the transducer to the acoustic chamber.

14. The portable electronic device of claim 12 wherein the transducer attenuator comprises a sealed end transmission line having a length that is an integer multiple of the ultrasonic sound wave output by the transducer, and the plurality of openings are arranged along the length of the transmission line to align the at least one opening with the pressure minimum point of the ultrasonic sound wave.

15. The portable electronic device of claim 12 wherein the transducer attenuator comprises a hollow disc having a first side comprising a center opening coupled to the sound output port of the transducer, and a second side arranged parallel to the first side through which the plurality of openings are formed.

16. The portable electronic device of claim 15 wherein the ultrasonic sound wave forms a meridional standing wave within the acoustic chamber, and each of the plurality of openings are aligned with a pressure minimum point of the meridional standing wave.

17. The portable electronic device of claim 12 wherein the transducer attenuator comprises a cone having a first side comprising an apex with a center opening coupled to the sound output port of the transducer, and a second side arranged parallel to the first side through which the plurality of openings are formed.

18. The portable electronic device of claim 12 wherein at least one opening of the plurality of openings defines a main channel extending from the acoustic chamber to the surrounding ambient environment, and a secondary channel extending from a side wall of the main channel that is tuned to attenuate the ultrasonic sound wave.

19. The portable electronic device of claim 12 further comprising a housing coupled to a side of the transducer attenuator through which the plurality of openings are formed and having a port to the surrounding ambient environment, and a chip scale attenuator acoustically coupled to the port to attenuate a remnant ultrasonic sound wave within the housing.

20. The portable electronic device of claim 12 wherein the device enclosure comprises a wearable device enclosure.
